(19) United States
(12) Patent Application Publication
(10) Pub. No.: US 2012/0115019 A1
(43) Pub. Date: May 10, 2012

(54) ENERGY STORAGE MODULE

(75) Inventors: Yeongsu CHO, Gyeonggi-do (KR); Changryul Jung, Seoul (KR); Junhee Bae, Seoul (KR); Baekyun Kim, Gyeonggi-do (KR); Hyunchul Jung, Gyeonggi-do (KR)

(73) Assignee: SAMSUNG ELECTRO-MECHANICS CO., LTD.

(21) Appl. No.: 13/103,703

(22) Filed: May 9, 2011

(30) Foreign Application Priority Data
Nov. 4, 2010 (KR) 10-2010-0109209

(51) Int. Cl. H01M 2/02; H01G 9/155

(52) U.S. Cl. 429/163; 361/502

(57) ABSTRACT

Provided is an energy storage module including a cell structure having at least one energy storage cell and a package structure which covers the cell structure to package the cell structure, wherein the package structure includes a metal foil and a protective coating layer which covers the metal foil and is made of at least one of a silicon-based material and a fluorine-based material.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2010-0109209, entitled filed Nov. 4, 2010, which is hereby incorporated by reference in its entirety into this application.

### BACKGROUND OF THE INVENTION

1. Field of the Invention

The present invention relates to an energy storage module, and more particularly, to an energy storage module capable of improving moisture-proof, waterproof, and water-repellent characteristics of an energy storage cell.

2. Description of the Related Art

An energy storage cell such as a secondary battery or a capacitor is manufactured into an energy storage module by being finally packaged after completion of manufacture thereof. A packaging technology for packaging the energy storage cell includes a technology for sealing the energy storage cell with a predetermined package structure to protect the energy storage cell from external environment.

As an example, in recent times, an energy storage cell, which is called an ultracapacitor or a supercapacitor is getting the spotlight as a new generation energy storage device due to a high charging and discharging speed, high stability, a high environment-friendly characteristic, a semi-permanent life characteristic, and so on. Since the supercapacitor cell has a characteristic that it has a semi-permanently long life, in order to semi-permanently protect the supercapacitor, a packaging process is required to improve moisture-proof, waterproof, and water-repellent efficiency of the package structure. However, it is difficult to continuously maintain moisture-proof, waterproof, and water-repellent characteristics of the cell by using a conventional general cell packaging technology, in response to an energy storage device having a semi-permanent life such as a supercapacitor cell.

### SUMMARY OF THE INVENTION

The present invention has been invented in order to overcome the above-described problems and it is, therefore, an object of the present invention to provide an energy storage module capable of improving moisture-proof, waterproof, and water-repellent characteristics of an energy storage cell.

Further, it is another object of the present invention to provide an energy storage module capable of improving reliability of a supercapacitor having a semi-permanent life.

In accordance with one aspect of the present invention to achieve the object, there is provided an energy storage module including: a cell structure having at least one energy storage cell; and a package structure which covers the cell structure to package the cell structure, wherein the package structure includes a metal foil and a protective coating layer which covers the metal foil and is made of at least one of a silicon-based material and a fluorine-based material.

In accordance with an embodiment of the present invention, the protective coating layer may cover both surfaces of the metal foil and be disposed at the outermost part of the package structure.

In accordance with an embodiment of the present invention, the protective coating layer may include a first coating layer which is disposed adjacent to the cell structure in comparison with the metal foil and closely adhered to the cell structure to completely cover the cell structure without voids and a second coating layer which is disposed opposite to the first coating layer with respect to the metal foil and exposed to the outside.

In accordance with an embodiment of the present invention, the metal foil may be made of an aluminum material.

In accordance with an embodiment of the present invention, the package structure may further include an insulator interposed between the metal foil and the protective coating layer, wherein the insulator may include an insulating film made of at least one material of nylon, poly ethylene terephthalate (PET), polyester, polypropylene (PP), fluorinated ethylene propylene (FEP), perfluoroalkoxy (PFA), polytetrafluoroethylene (PTFE), and polyethylene (PE), and the insulating film may be formed by performing film casting on the metal foil.

In accordance with an embodiment of the present invention, the package structure may further include an insulator interposed between the metal foil and the protective coating layer, wherein the insulator may include a foundation layer which covers the metal foil and an insulating film which covers the foundation film, and the insulating film may be made of at least one material of nylon, poly ethylene terephthalate (PET), polyester, polypropylene (PP), fluorinated ethylene propylene (FEP), perfluoroalkoxy (PFA), polytetrafluoroethylene (PTFE), and polyethylene (PE).

In accordance with an embodiment of the present invention, the insulator may further include an adhesive layer interposed between the foundation layer and the insulating film.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing an energy storage module in accordance with an embodiment of the present invention; and

FIG. 2 is a view showing a cross section of a package structure shown in FIG. 1.

### DETAILED DESCRIPTION OF THE PREFERABLE EMBODIMENTS

Advantages and features of the present invention and a method of achieving the advantages and the features will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art. Like reference numerals refer to like elements throughout the specification.

The terms used herein are provided to explain a particular embodiment, not limiting the present invention. As used in this specification, a singular form may include a plural form unless the context clearly indicates otherwise. In the present specification, the terms “comprise” and/or “comprising” do not exclude the existence or addition of one or more other components, steps, operations, and/or elements.

Hereinafter, an energy storage module in accordance with the present invention will be described in detail with reference to the accompanying drawings.

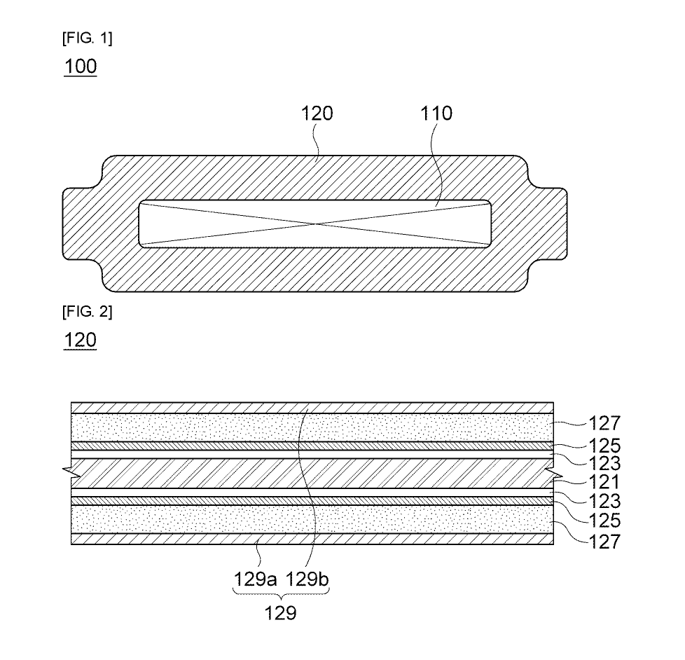

FIG. 1 is a view showing an energy storage module in accordance with an embodiment of the present invention, and FIG. 2 is a view showing a cross section of a package structure shown in FIG. 1.

Referring to FIGS. 1 and 2, an energy storage module 100 in accordance with an embodiment of the present invention may include a cell structure 110 and a package structure 120 for packaging the cell structure 110.

The cell structure 110 may include at least one energy storage device. As an example, the cell structure 110 may include at least one supercapacitor. In this case, the cell structure 110 may include at least one of an electric double layer capacitor (EDLC), a pseudocapacitor, and a hybrid capacitor. As another example, the cell structure 110 may include a secondary battery. In this case, the cell structure 110 may include at least one lithium ion battery.

In case that the cell structure 110 includes a supercapacitor, the cell structure 110 has a relatively long life in comparison with a case that the cell structure 110 includes a secondary battery. That is, the supercapacitor has a characteristic that it has a semi-permanent life in comparison with the secondary battery. Therefore, in order to meet this characteristic, the package structure 120 may also be configured to provide semi-permanent moisture-proof, waterproof, and water-repellent characteristics to the cell structure 110.

The package structure 120 may cover the cell structure 110 to seal the cell structure 110 from external environment. The package structure 120 may include a protective case for covering the cell structure 110. The protective case may be closely adhered to the cell structure 110. For the adhesion of the protective case, the package structure 120 may be configured to be deformable according to the shape of the cell structure 110. That is, the package structure 120 may be configured to have ductility so that it can be deformed according to the shape of the cell structure 110. Further, in order to improve the adhesion between the package structure 120 and the cell structure 110, it may be configured to maintain a vacuum state between the package structure 120 and the cell structure 110. For this, it may be configured to exhaust air inside the package structure 120 to the outside in a state in which the package structure 120 surrounds the cell structure 110 so that the protective case is adhered to the cell structure 110 to cover the cell structure 110. The package structure 120 can completely cover the cell structure 110 without occurrence of voids between the cell structure 110 and the protective case.

The protective case of the package structure 120 may include a metal foil 121, an insulator, and a protective coating layer 129. The insulator and the protective coating layer 129 may be sequentially laminated on both surfaces of the metal foil 121. Accordingly, the protective case may consist of the metal foil 121, the insulator which covers the both surfaces of the metal foil 121, and the protective coating layer 129 which covers the insulator.

The metal foil 121 may be a thin plate type foil made of various kinds of metal. As an example, the metal foil 121 may be a metal thin plate made of aluminum (Al).

The insulator may include a plurality of insulating layers which are sequentially laminated on the both surfaces of the metal foil 121. As an example, the insulator may include a foundation layer 123, an adhesive layer 125, and an insulating film 127 which are sequentially laminated on the metal foil 121.

The foundation layer 123 may directly cover the both surfaces of the metal foil 121. Various kinds of insulating layers may be used as the foundation layer 123. At this time, it may be preferred that an insulating layer for the foundation layer 123 is made of a material having high adhesion with the adhesive layer 125 as well as the metal foil 121.

The adhesive layer 125 may bond the metal foil 121 including the foundation layer 123 and the insulating film 127 to each other. As an example, the adhesive layer 125 may be configured by forming an adhesive made of a resin on the foundation layer 123.

The insulating film 127 may be formed to cover the adhesive layer 125. The insulating film 127 may be a film made of various kinds of insulating materials. As an example, the insulating film 127 may be a film made of at least one material of nylon, poly ethylene terephthalate (PET), polyester, polypropylene (PP), fluorinated ethylene propylene (FEP), perfluoroalkoxy (PFA), polytetrafluoroethylene (PTFE), and polyethylene (PE). In this case, the insulating film 127 may be formed by laminating a PET film on the adhesive layer 125. The lamination of the PET film may be performed by film casting.

The protective coating layer 129 may be the outermost layer of the protective case. In this case, the protective coating layer 129 may include a first coating layer 129a and a second coating layer 129b which are formed at both sides with respect to the metal foil 121, respectively.

The first coating layer 129a may be disposed adjacent to the cell structure 110 in comparison with the metal foil 121. Therefore, the first coating layer 129a is in direct contact with the cell structure 110 to cover the cell structure 110. Here, the first coating layer 129a may cover the cell structure 110 without voids between the first coating layer 129a and the cell structure 110. The first coating layer 129a having the above structure can prevent penetration of external moisture from the package structure 120 into the cell structure 110. Meanwhile, the second coating layer 129b may be formed opposite to the first coating layer 129a with respect to the metal foil 121. Accordingly, the second coating layer 129b may be exposed to the outside to prevent penetration of external moisture into the energy storage module 100.

Meanwhile, the protective coating layer 129 may be made of a material having very high moisture-proof, waterproof, and water-repellent characteristics. As an example, the protective coating layer 129 may be made of a silicon-based moisture-proof material such as silicon elastomer. As another example, the protective coating layer 129 may be made of a fluorine (F)-based moisture-proof material such as a fluorine-based coating agent.

The protective coating layer 129 can prevent penetration of external moisture into the cell structure 110 as well as protect the cell structure 110 from external environment. Especially, since the protective coating layer 129 includes the first coating layer 129a and the second coating layer 129b which are formed at both sides with respect to the metal foil 121, respectively, the package structure 120 may have a structure in which external moisture is primarily blocked by the second coating layer 129b and secondarily blocked by the first coating layer 129a. Further, external moisture can be blocked from penetrating into the cell structure 110 by the metal foil 121. Therefore, the package structure 120 can greatly improve moisture-proof, waterproof, and water-repellent characteristics of the cell structure 110 by blocking penetration of external moisture by stages.

As described above, the energy storage module 110 in accordance with an embodiment of the present invention may include the cell structure 110 and the package structure 120 which covers the cell structure 110 to protect the cell structure 110 from external environment. The package structure 120 may include the metal foil 121 and the protective coating layer 129 which covers the metal foil 121 and blocks external moisture from penetrating into the cell structure 110. Here, the protective coating layer 129 consists of two or more coating layers with respect to the metal foil 121 and can block penetration of external moisture into the cell structure 110 several times. Accordingly, the energy storage module in accordance with the present invention has a structure capable of preventing penetration of external moisture into the cell structure several times and thus can improve the moisture-proof, waterproof, and water-repellent characteristics of the energy storage cell.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. An energy storage module comprising:
a cell structure having at least one energy storage cell; and
a package structure which covers the cell structure to package the cell structure, wherein the package structure comprises:
a metal foil; and
a protective coating layer which covers the metal foil and is made of at least one of a silicon-based material and a fluorine-based material.

2. The energy storage module according to claim 1, wherein the protective coating layer covers both surfaces of the metal foil and is disposed in the outermost part of the package structure.

3. The energy storage module according to claim 1, wherein the protective coating layer comprises:
a first coating layer which is disposed adjacent to the cell structure in comparison with the metal foil and closely adhered to the cell structure to completely cover the cell structure without voids; and
a second coating layer which is disposed opposite to the first coating layer with respect to the metal foil and exposed to the outside.

4. The energy storage module according to claim 1, wherein the metal foil is made of an aluminum material.

5. The energy storage module according to claim 1, wherein the package structure further comprises an insulator interposed between the metal foil and the protective coating layer, wherein the insulator comprises an insulating film made of at least one material of nylon, poly ethylene terephthalate (PET), polyester, polypropylene (PP), fluorinated ethylene propylene (FEP), perfluroalkoxy (PFA), polytetrafluoroethylene (PTFE), and polyethylene (PE), wherein the insulating film is formed by performing film casting on the metal foil.

6. The energy storage module according to claim 1, wherein the package structure further comprises an insulator interposed between the metal foil and the protective coating layer, wherein the insulator comprises:
a foundation layer which covers the metal foil; and
an insulating film which covers the foundation layer, wherein the insulating film is made of at least one material of nylon, poly ethylene terephthalate (PET), polyester, polypropylene (PP), fluorinated ethylene propylene (FEP), perfluroalkoxy (PFA), polytetrafluoroethylene (PTFE), and polyethylene (PE).

7. The energy storage module according to claim 6, wherein the insulator further comprises an adhesive layer interposed between the foundation layer and the insulating film.
